(19) United States
(12) Patent Application Publication
(10) Pub. No.: US 2020/0242958 A1
(43) Pub. Date: Jul. 30, 2020

(54) COMPUTER-IMPLEMENTED SYSTEM AND METHOD FOR LEARNING AND ASSESSMENT

(71) Applicants: Rizwan Tufail, Oakville (CA); Maciej Natan Caputa, Warsaw (PL)

(72) Inventors: Rizwan Tufail, Oakville (CA); Maciej Natan Caputa, Warsaw (PL)

(21) Appl. No.: 16/773,366

(22) Filed: Jan. 27, 2020

Related U.S. Application Data
(60) Provisional application No. 62/797,092, filed on Jan. 25, 2019.

(51) Int. Cl. G09B 7/077; G06F 17/18

(52) U.S. Cl. CPC G09B 7/077; G06F 17/18

(57) ABSTRACT

A method for learning and assessment using a computing device is provided includes: storing a plurality of mathematical problems in a database; for each of the plurality of mathematical problems, generating, by the computing device, a set of micro-skills that are required to solve the mathematical problem, the set of micro-skills being selected from a plurality of pre-defined micro-skills, each micro-skill being a smallest component of learning; for each of the plurality of mathematical problems, storing the set of micro-skills corresponding to the problem in the database; delivering one or more of the plurality of mathematical problems to a user via a computer interface of the computing device; for each delivered mathematical problem, receiving a plurality of intermediate step inputs from the user through the computer interface, and recording a plurality of time durations corresponding to the plurality of intermediate step inputs; creating, by the computing device, a skill profile of the user according to the plurality of intermediate step inputs and the plurality of recorded time durations, the skill profile including skill levels of the user in a plurality of micro-skill categories; storing the skill profile in a user entry corresponding to the user in the database; generating, by the computing device, a conceptual map of the user according to the skill profile; and outputting the conceptual map of the user by the computing device.

### REFERENCE TO RELATED APPLICATIONS

This application claims the priority of U.S. Provisional Application No. 62/797,092, filed on Jan. 25, 2019, the entire contents which is incorporated herein by reference.

### BACKGROUND OF THE INVENTION

### Field of the Invention

The present invention relates to a computerized machine based learning system and method, and more particularly, to a system and method for enhancing mathematics learning and assessment through conceptual mapping.

### Motivation and Description of Related Art

Over the years, there has been persistent interest in creating a universal benchmark of measuring and analyzing mathematics knowledge and skills of individual students as well as at the level of entire schooling systems. Efforts such as the Program for International Student Assessment (PISA) are an attempt to do through a series of universal assessments. These assessments have usually been in the form of multiple-choice norm-referenced tests. However, several researchers have studied these testing programs and found them to be inconsistent with the current goals of mathematics education. Furthermore, multiple-choice questions can be culturally biased, reducing their effectiveness as a universal measure.

Therefore, there is a continued need for improved tools and methods for measuring and analyzing students' mathematics knowledge and skills.

### SUMMARY OF THE INVENTION

The objective of the present invention to overcome the challenges of currently available tools for assessing the mathematics learning skills and knowledges, by creating a way to measure and record understanding of mathematics skills at an extremely discrete levels. The method of the present invention is termed as the Conceptual Mapping for Mathematics Learning Method (CMMLM) and Conceptual Mapping for Mathematics Learning System (CMMLS). The present invention offers an alternative to the traditional testing and teaching strategy of multiple-choice questions for the student to write an answer for each question.

According to certain embodiments, the CMMLM first analyzes the targeted mathematics problem/exercise and break it down into discrete and microscopic steps and skills. These discrete steps and skills are at a much smaller level than the learning objectives used to measure progress in traditional settings. The objective is to create small learning steps that are involved in a student's learning and to creating an inventory of mathematical skills needed to apply mathematical learning at more advanced level. The central idea is that to solve any mathematical questions, the student calls on an already developed repertoire of micro-skills. By interrogating, and mapping the strength of these micro-skills, it is possible to develop a better understanding of current skills-base, with the idea of strengthening, in an extremely focused set of exercises, those skills that need strengthening rather than a broad brush approach. In this way not only can learning be personalized, and customized to the current skill level of each student but is also possible to intervene surgically, and help strengthen exactly those skills that need to be strengthened through practice, understanding and assimilation.

According to certain embodiments, the CMMLM represents the mathematics micro-skills in an intuitive graphic interface by making a Conceptual Map. This visual representation has multiple advantages: It is a quick and transparent way to understand strength profile; It is easy to visualize and create action plans for learners, teachers and parents; The transparent data-driven analysis can be presented in an easy-to-consume and understand manner with the Conceptual Map.

According to certain embodiments, a Conceptual Mapping for Mathematics Learning System (CMMLS) is provided to translate the Conceptual Mapping for Mathematics Learning Method (CMMLM) into the Conceptual Map (CM). The system is an advanced mathematics practice, gaming as well as assessment system, which records a number of factors in real-time to track learning progress, as well as understanding of students. It uses this information to create an individualized skills-profile of a student, which is then used to create the Conceptual Map. As students begin to interact with the Conceptual Mapping for Mathematics Learning System (CMMLS), the Conceptual Map is populated with real data from the student's interaction. The student's performance, and comfort-level, is measured and compared against a benchmark to evaluate whether it meets the required mastery level or not; the performance of the student is measured both in terms of accuracy (correctness of the response), as well as speed (time taken to answer) to analyze performance. Finally, the student's performance in the 100+ benchmarks is then represented on the map, and color-coded by level of mastery.

According to certain embodiments, the CMMLS has multiple key components, including: the Quizzing Engine, the Analysis Engine, the Gaming Engine (Optional), the Questions Generator, the Conceptual Map, the Questions Databank, and Students Database. These key components interact with each other and synergistically contribute the functionalities of the CMMLS.

In one aspect of the present disclosure, a method for learning and assessment using a computing device is provided. The method includes: storing a plurality of mathematical problems in a database; for each of the plurality of mathematical problems, generating, by the computing device, a set of micro-skills that are required to solve the mathematical problem, the set of micro-skills being selected from a plurality of pre-defined micro-skills, each micro-skill being a smallest component of learning; for each of the plurality of mathematical problems, storing the set of micro-skills corresponding to the problem in the database; delivering one or more of the plurality of mathematical problems to a user via a computer interface of the computing device; for each delivered mathematical problem, receiving a plurality of intermediate step inputs from the user through the computer interface, and recording a plurality of time durations corresponding to the plurality of intermediate step inputs; creating, by the computing device, a skill profile of the user according to the plurality of intermediate step inputs and the plurality of recorded time durations, the skill profile including skill levels of the user in a plurality of micro-skill categories; storing the skill profile in a user entry corresponding to the user in the database; generating, by the computing device, a conceptual map of the user according to the skill profile; and outputting the conceptual map of the user by the computing device.

In certain embodiments, the method further includes: assigning a plurality of skill codes to the plurality of pre-defined micro-skills.

In certain embodiments, the method further includes: assigning a set of category codes to each of the plurality of mathematical problems, each category code corresponding to a category of mathematical knowledge required to solve the mathematical problem.

In certain embodiments, generating the conceptual map of the user according to the skill profile includes: generating benchmark skill levels of the user by comparing the skill levels of the user to predefined standard skill levels in the plurality of micro-skill categories; and color-coding the benchmark skill levels of the user in the plurality of micro-skill categories.

In certain embodiments, the pre-defined standard skill levels are generated based on one of: average skill levels of all learners across the globe of a same age range, average skill levels of all learners across the globe of a same grade, and average skill levels of learners within a same geographical boundary.

In certain embodiments, the method further includes: evaluating, by the computing device, performance of the user based on one of a percentile, a median, a standard deviation, and an average measured according to the pre-defined standard skill levels.

In certain embodiments, the method further includes: updating the pre-defined standard skill levels according to a plurality of previously-generated user entries.

In certain embodiments, the method further includes: storing demographic information of the user in the user entry in the database.

In certain embodiments, the method further includes: selecting the one or more mathematical problems to deliver to the user according to a previously-generated skill profile of the user.

In certain embodiments, the method further includes: generating one or more variable-path mathematical problems to deliver to the user according to a previously-generated skill profile of the user, wherein each variable-path mathematical problem is associated with one or more micro-skills and/or one or more category codes that have been selected for the user to practice according to the previously-generated skill profile.

In certain embodiments, the method further includes: generating one or more application-path mathematical problems to deliver to the user according to a previously-generated skill profile of the user, wherein the application math mathematical problems are word problems related to practical applications.

In certain embodiments, the plurality of mathematic problems stored in the database include 100,000 or more mathematic problems.

In certain embodiments, the plurality of pre-defined micro-skills include 100 or more micro-skills and the plurality of category codes include 100 or more category codes.

In certain embodiments, receiving the plurality of intermediate step inputs includes: receiving handwritten input form the user through the computer interface; and converting the handwritten input into one or more of a text, a number, and a formula through text and template recognition.

In certain embodiments, the method further includes: calculating a mathematical intelligence quotient (MIQ) of the user, including: calculating a math score of the user as a weighted average of scores obtained for at least two micro-skills, and normalizing the math score of the user to an average math score of students in a same age range.

In certain embodiments, the method further includes: delivering one or more of the plurality of mathematic problems to the user in a computer game environment on the computing device, wherein the computer game environment provides a plurality of game scenarios, each game scenario being associated with one or more micro-skills that have been selected for the user to practice according to a previously-generated skill profile of the user.

In another aspect of the present disclosure, a non-transitory computer readable storage medium is provided. The non-transitory computer readable storage medium stores a set of computer-executable instructions, wherein when being executed by a processor, the set of computer-executable instructions cause the processor to: store a plurality of mathematical problems in a database; for each of the plurality of mathematical problems, store a set of micro-skills corresponding to the problem in the database, the set of micro-skills being selected from a plurality of pre-defined micro-skills; deliver one or more of the plurality of mathematical problems to a user via a computer interface of the computing device; for each delivered mathematical problem, receive a plurality of intermediate step inputs from the user through the computer interface, and record a plurality of time durations corresponding to the plurality of intermediate step inputs; create a skill profile of the user according to the plurality of intermediate step inputs and the plurality of recorded time durations, the skill profile including skill levels of the user in a plurality of micro-skill categories; store the skill profile in a user entry corresponding to the user in the database; generate a conceptual map of the user according to the skill profile; and output the skill map of the user.

In certain embodiments, the set of computer-executable instructions further cause the processor to: assign a plurality of skill codes to the plurality of pre-defined micro-skills.

In certain embodiments, the set of computer-executable instructions further cause the processor to: assign a set of category codes to each of the plurality of mathematical problems, each category code corresponding to a category of mathematical knowledge required to solve the mathematical problem.

In certain embodiments, the set of computer-executable instructions further cause the processor to: generate benchmark skill levels of the user by comparing the skill levels of the user to predefined standard skill levels in the plurality of micro-skill categories; and color-code the benchmark skill levels of the user in the plurality of micro-skill categories.

The above invention aspects will be made clear in the drawings and detailed description of the invention.

### BRIEF DESCRIPTION OF THE DRAWINGS

FIG. 1A shows examples of symbols used in the skill codes according to certain embodiments;

FIG. 1B shows examples of abbreviations used in the system according to certain embodiments;

FIG. 2 shows four types of skill codes according to certain embodiments;

FIG. 3 shows examples of BODMAS skill codes according to certain embodiments;

FIG. 4A shows definition and examples of numerical skill codes according to certain embodiments;

FIG. 4B shows definition and examples of numerical skill codes according to certain embodiments;

FIG. 5A shows operational skill codes examples: fraction;

FIG. 5B shows operational skill codes examples: powers;

FIG. 5C shows operational skill codes examples: roots;

FIG. 5D shows operational skill codes examples: logarithms;

FIG. 5E shows operational skill codes examples: geometry;

FIG. 5F shows operational skill codes examples: trigonometry;

FIG. 5G shows operational skill codes examples: arithmetic and geometric sequences;

FIG. 5H shows operational skill codes examples: limits;

FIG. 5I shows operational skill codes examples: differentiation;

FIG. 5J shows operational skill codes examples: vectors;

FIG. 5K shows operational skill codes examples: probability;

FIG. 6A shows a raw Conceptual Map according to certain embodiments;

FIG. 6B shows a conceptual Map of a fictional, illustrative learner according to certain embodiments;

FIG. 6C shows Skill/Code Annotations according to certain embodiments;

FIG. 6D shows a student's performance relative to other students according to certain embodiments;

FIG. 6E shows a conceptual Map Key according to certain embodiments;

FIG. 6F shows conceptual map annotations according to certain embodiments;

FIG. 7 shows aggregation levels according to certain embodiments;

FIG. 8A shows CMMLS components and interactions according to certain embodiments;

FIG. 8B shows quizzing engine components according to certain embodiments;

FIG. 8C shows analysis engine components according to certain embodiments;

FIG. 8D shows variable questions generator according to certain embodiments;

FIG. 9 shows n example of quizzing interface according to certain embodiments;

FIG. 10A shows a first example of Additive Digit Relation;

FIG. 10B shows a second example of Additive Digit Relation;

FIG. 11A shows data display for session information according to certain embodiments;

FIG. 11B shows data display for student performance according to certain embodiments;

FIG. 12 illustrates a method for learning and assessment according to certain embodiments; and

FIG. 13 illustrates a system for learning and assessment.

### DETAILED DESCRIPTION OF THE INVENTION

In the detailed description, numerous specific details are set forth in order to provide a thorough understanding of the invention. However, it will be understood by those skilled in the art that these are specific embodiments, and that the present invention may be practiced also in different ways that embody the characterizing features of the invention as described and claimed herein.

In one aspect of the present invention, the CMMLM first analyzes the targeted mathematics problem/exercise and break it down into discrete and microscopic steps and skills. In the following embodiment, examples of micro skills are defined and presented. It is noted that the presentation format of the skills is for convenience. Other form of presentation can be used. In addition, other micro skills may exist.

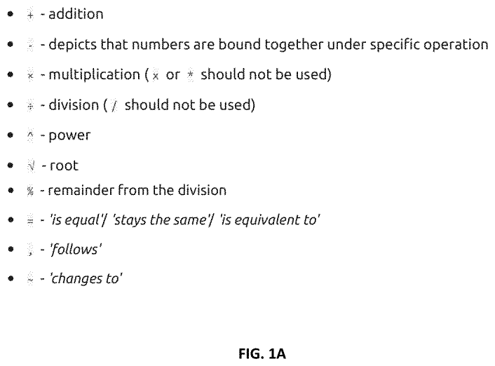

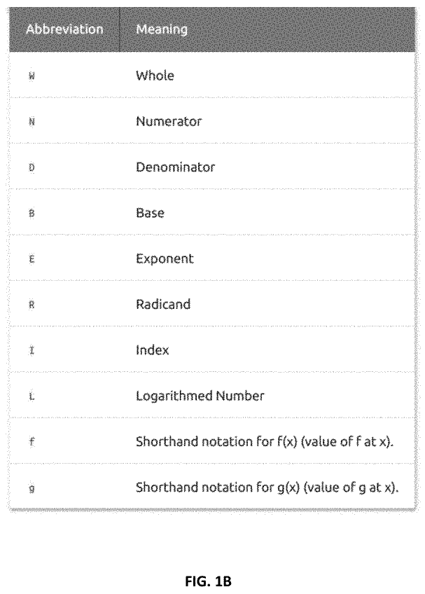

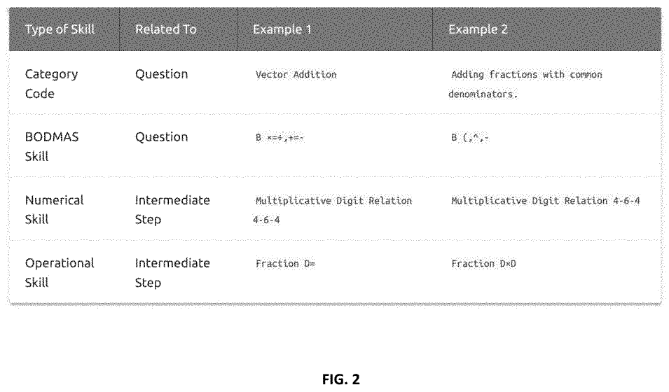

In the present disclosure, a micro-skill refers to a specific competency that is part of the overall capabilities required to accomplish a certain learning task. For example, the micro-skills can be represented in a compact and straightforward manner with skill codes. FIG. 1A shows some common symbols used in the skill codes. FIG. 1B shows some abbreviation used in the conceptual maps. FIG. 2 shows four types of skill codes in certain embodiments of the present invention: Category codes, BODMAS skills, numerical skill and operational skill.

The category codes can be of various forms. For example, the category codes include category and operation. They can be represented in the syntax:

[Category][Operation]

Possible values for [Level] include: Horizontal, Vertical, Fraction, Power, Root, Logarithm, Linear, Quadratic, Polynomial, Sequence, Vector, and Matrix.

Possible values for [Category] include Horizontal, Vertical, Fraction, Decimal, Power, Root, Logarithm, Vector, and Matrix.

Possible values for [Operation] include Addition, Subtraction, Multiplication, Division, Evaluation, Simplification, Expansion, Factorization, and Transformation.

Category codes are of type but are not limited to:

[Category][Operation]

[Single/Double/Triple]-Digit Horizontal/Vertical [Operation]

Horizontal/Vertical [Operation] Under [Max]

Horizontal/Vertical [Operation] With/Without Regrouping

Integer/Decimal Horizontal/Vertical [Operation]

Horizontal/Vertical Division With/Without Remainder

BODMAS codes is a subgroup of category codes and are of the following form B (,\hat{ }=√,×=÷,+=− where

, means ‘after’,

and = means ‘and’.

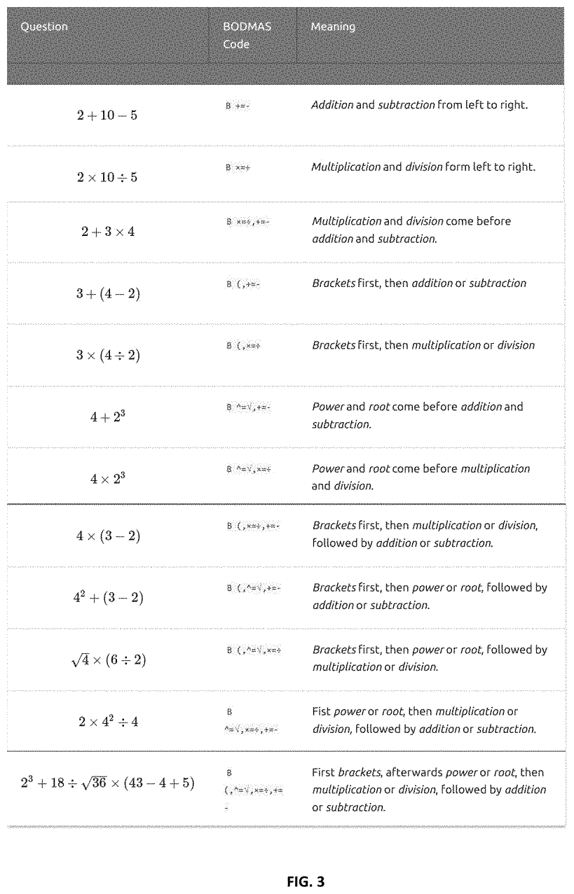

A few examples of BODMAS skill codes are shown in FIG. 3.

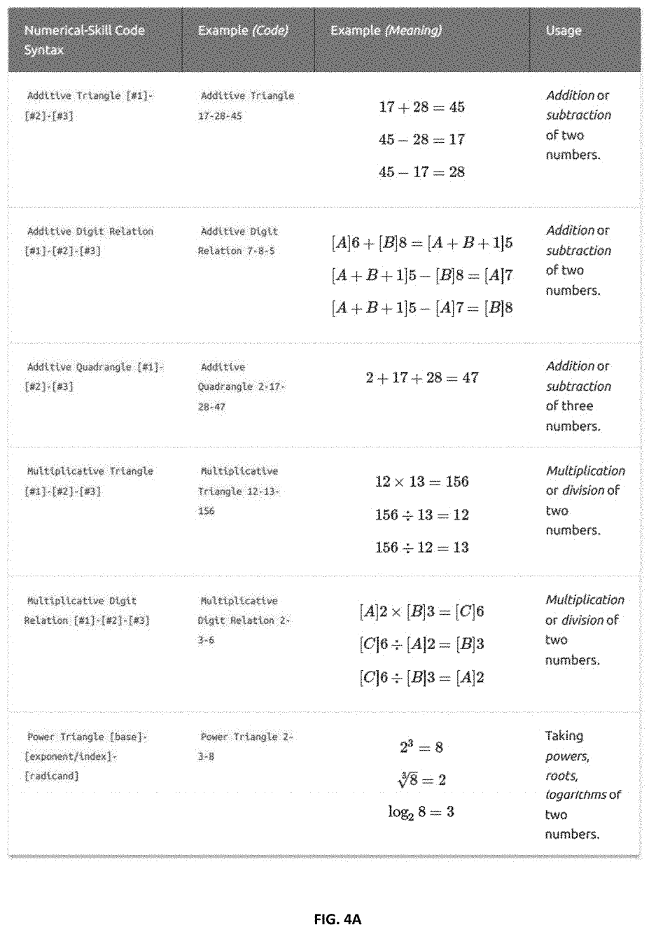

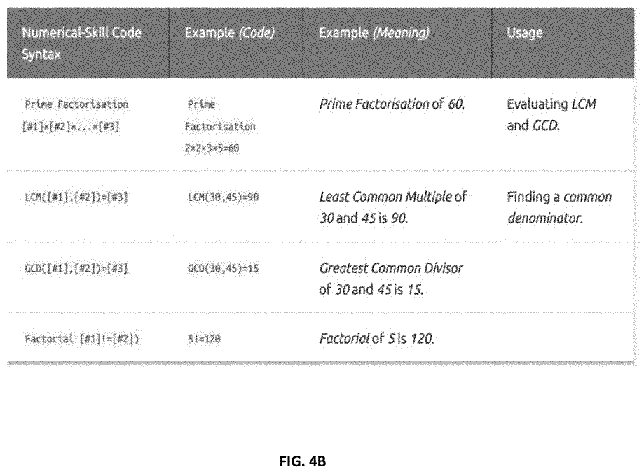

Numerical skills are related to the specific intermediate step (not to the question). FIG. 4A and 4B show the definition and examples of numerical skill codes.

Similarly, in certain embodiments, operational skills are related to the specific intermediate step (not to the question). Operational skills constitute for a special subset of micro skills and therefore are not a separate type of skill. Operational-skill codes capture what the student needs to know to understand the question correctly.

Semantics (shortened representation). For example Limit Skill lim(f+g) can be shorten into Limit f+g to convey the same information in more concise and short fashion.

NOTE: Some operational skills could also be used as category codes, which means that we could also assign some of them to a question. However, there is a value in assigning them directly into intermediate steps so that we know where a student has made a mistake.

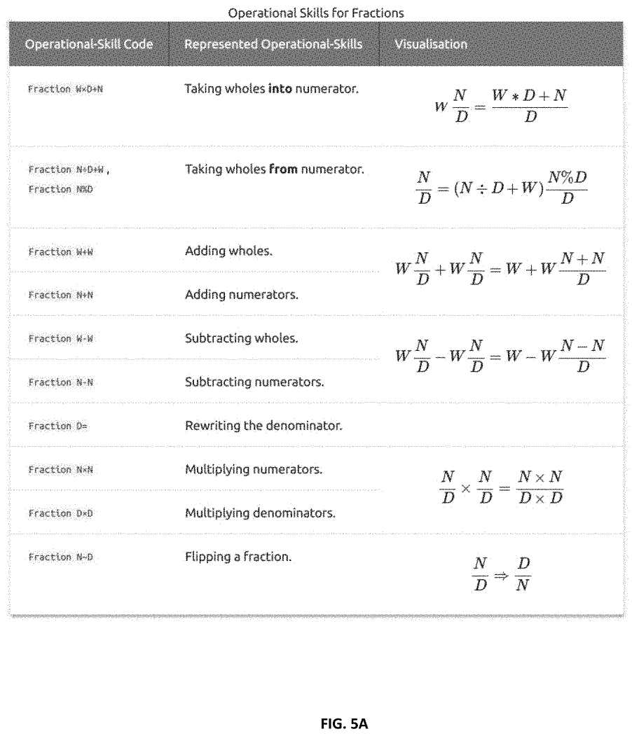

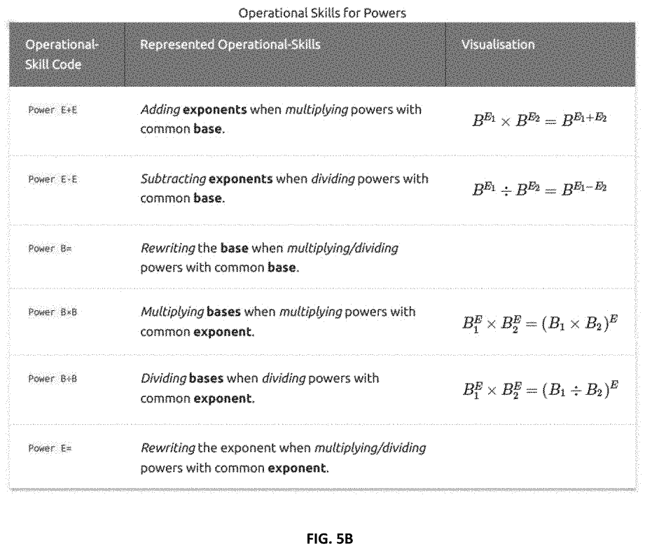

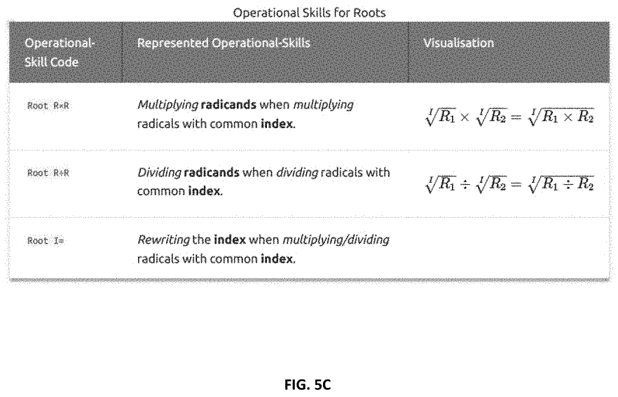

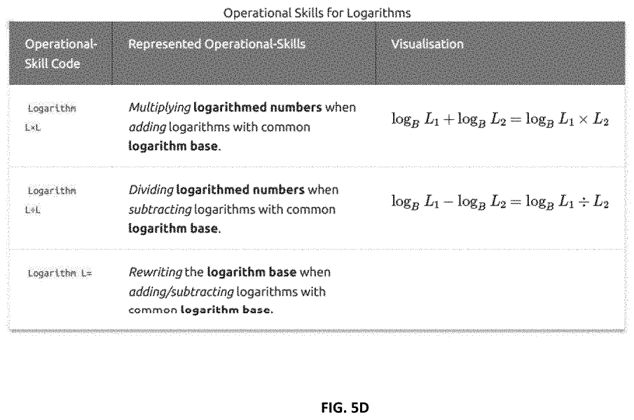

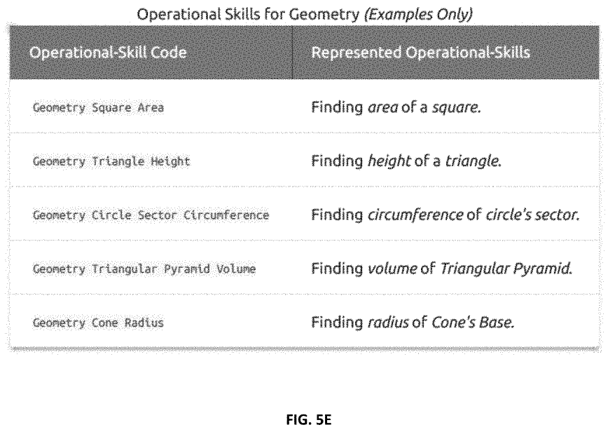

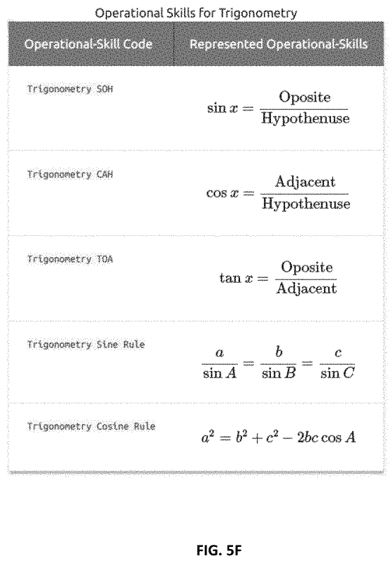

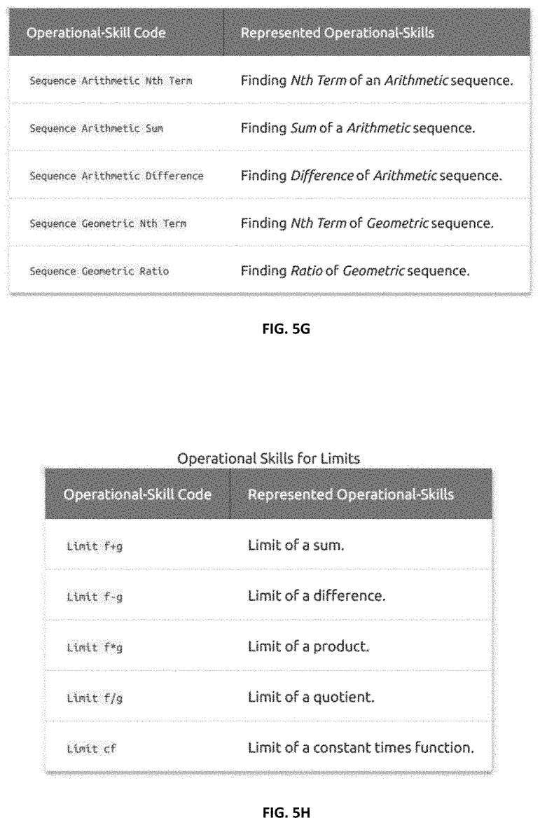

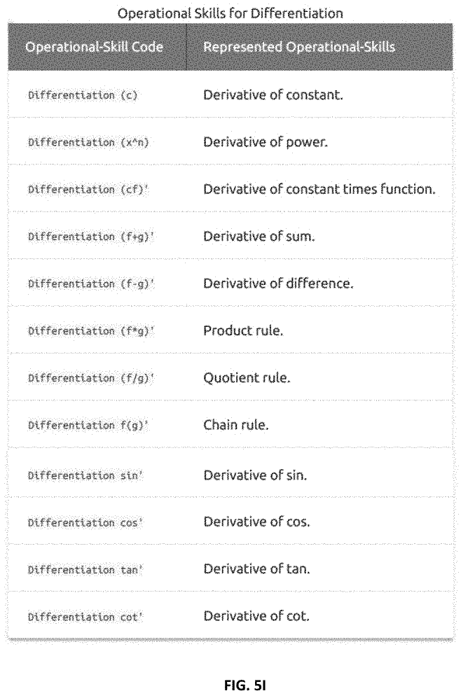

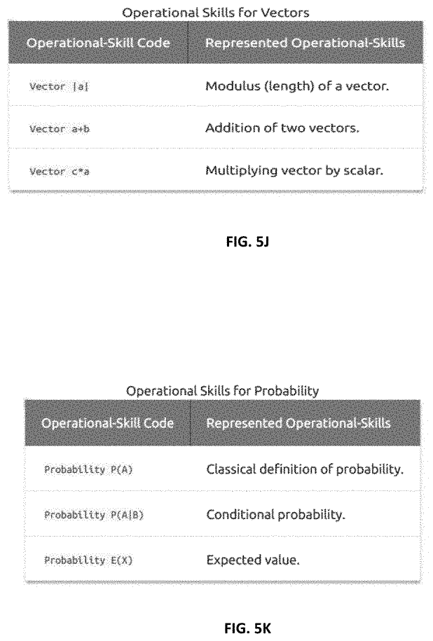

FIGS. 5A-5D show examples of operational skill codes including fraction, roots, power, and logarithms.

In certain embodiments, geometry operational-skills are defined in a form of Geometry [Geometric/Solid Figure] [Solving For].

Possible values for [Geometric/Solid Figure] include: Triangle; Trapezium; Parallelogram; Rhombus; Rectangle; Square; Pentagon; Hexagon; Circle; Cube; Triangular/Rectangular Prism; Triangular/Rectangular Pyramid; Cone; Cylinder; Sphere.

Possible values for [Solving For] include:

Perimeter [of base/face]/Circumference [of sector]; Area [of base/face/sector]; Volume; Height; Side/Edge; Diagonal; Radius.

FIGS. 5E shows examples of operational skills for geometry. FIGS. 5F-5K show examples of operational skill codes for trigonometry, arithmetic and geometric sequences, limits, differentiation, vectors, and probability. Additional categories of operational skill codes can be created similarly.

After the micro-skills and associated codes are established, the Conceptual Mapping for Mathematics Learning Method (CMMLM) is developed. Utilizing the CMMLM, mathematic problems and exercises can be broken down into the discrete micro-skills involved.

In certain embodiments, Conceptual Maps are developed to represent these micro-skills in a graphical interface. As students begins to interact with the CMMLS (described later), the Conceptual Map is populated with real data from the student's interaction. The student's performance, and comfort-level, is measured and compared against a benchmark to evaluate whether it meets the required mastery level or not; the performance of the student is measured both in terms of accuracy (correctness of the response), as well as speed (time taken to answer) to analyze performance. Finally, the student's performance in the 100+ benchmarks is then represented on the map, and color-coded by level of mastery. Note it is possible to create multiple views of the Conceptual Map for each student, depending on the normative benchmark. The student's performance or skill levels may be compared against: Other students of same age level; Other students of same grade level; Other students within same geographical boundaries or across countries (across different education systems).

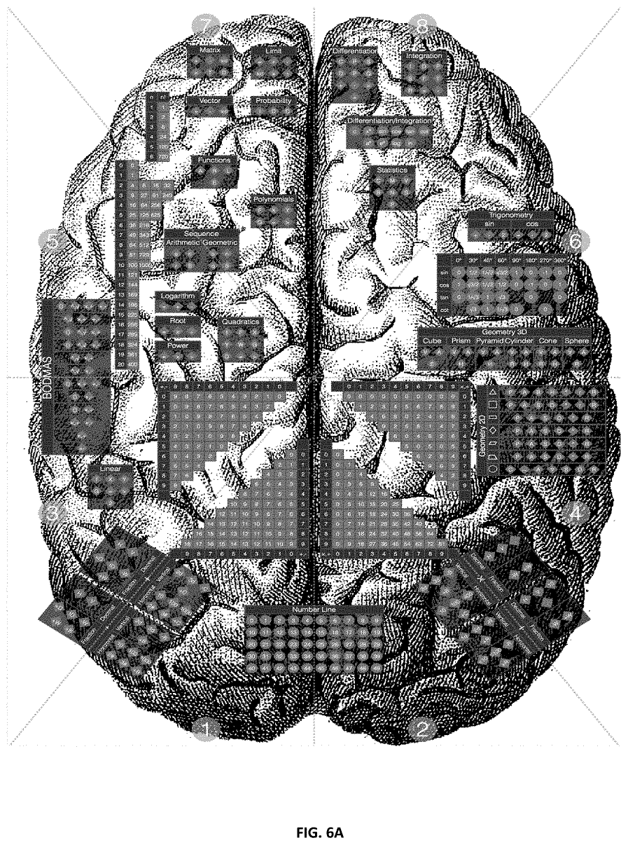

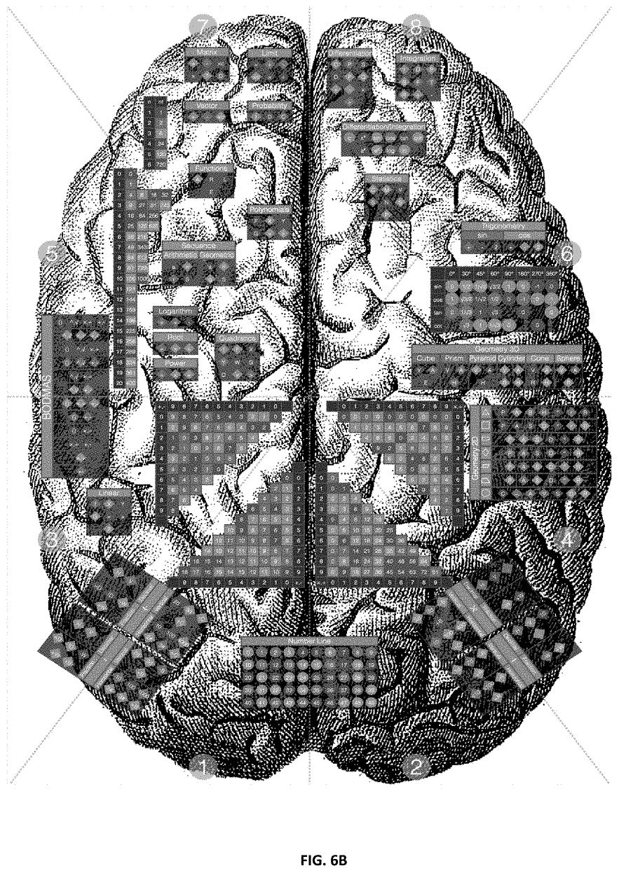

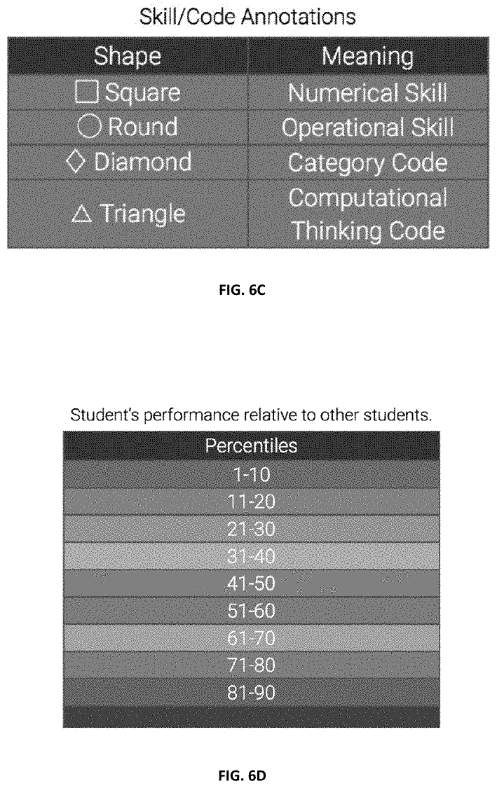

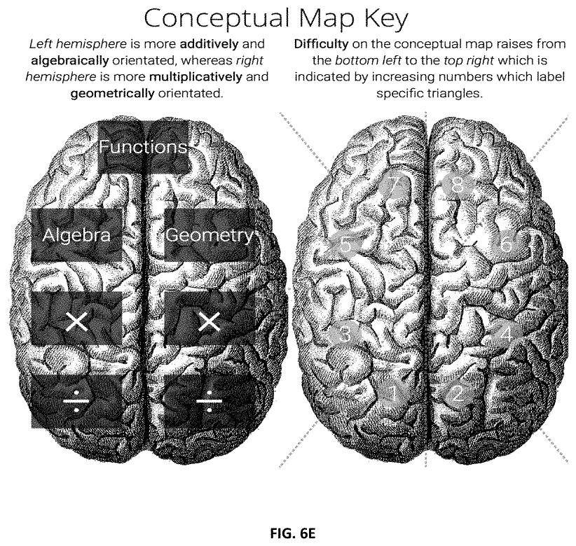

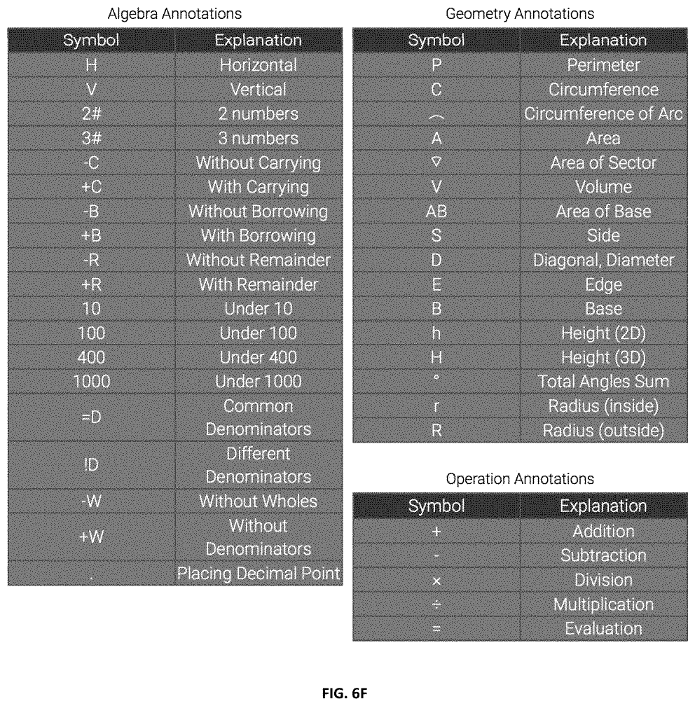

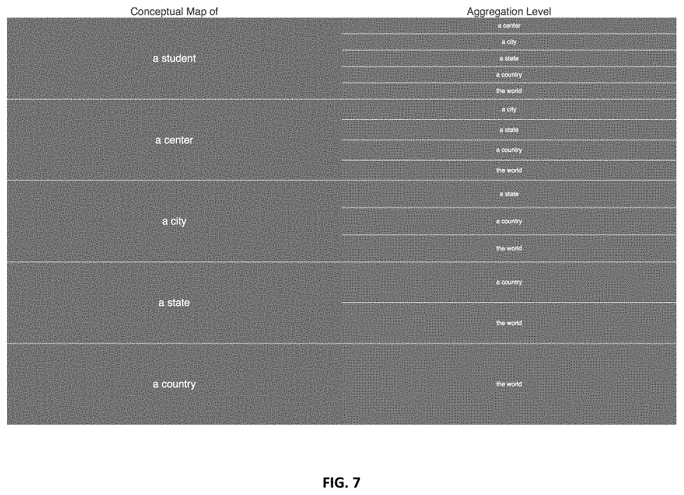

The diagram shown in FIG. 6A is an example of a raw Conceptual Map and FIG. 6B shows an example of a color-coded Conceptual Map of a fictional, illustrative learner. FIG. 6C shows the skill codes annotation and FIG. 6D shows the color-coding of a student's performance percentile compared to other students. FIG. 6E shows the Conceptual Map Key. FIG. 6F shows examples of conceptual map annotations.

There are multiple options to choose from when creating a conceptual map. In certain embodiments, conceptual maps may be created for a single student or for an aggregate of students, for example, students of a center, a state, a country, or the world. The conceptual maps of aggregate of students allow the observation of regional or global trends. For example, in some embodiments, the categories of the conceptual map options may include:

1. Persons—there are 6 of them namely a student, a center, a city, a state, a country, and the world;

2. Comparison basis—there are 2 of them namely performance benchmarks, and compound;

3. (Available if a compound comparison basis is chosen) Aggregation levels—there are 5 of them namely a center, a city, a state, a country, and the world;

4. Session/time spans—there are 8 of them namely current session, last 10 sessions, last 20 sessions, today, last week, last month, last year, and overall;

Note that aggregation levels are only to be chosen from if and only if comparison basis is chosen to be compound.

FIG. 7 shows an example of corresponding aggregation level for each person. For each person and corresponding valid aggregation level time span and comparison basis is also to be chosen. Examples include: Conceptual map of a student at an aggregate level of other students within a center for last 20 sessions, based on students' age; Conceptual map of a center at an aggregate level of other centers within a state for last week, based on students' age; and Conceptual map of a city at an aggregate level of other cities within a country for last 10 sessions, based on students' level.

The key to translating from the Conceptual Mapping for Mathematics Learning Method (CMMLM) to the Conceptual Map (CM) is the Conceptual Mapping for Mathematics Learning System (CMMLS). The system is an advanced mathematics practice, gaming as well as assessment system, which records a number of factors in real-time to track learning progress, as well as understanding of students. It uses this information to create an individualized skills-profile of a student, which is then used to create the Conceptual Map.

In certain embodiments of the present invention, the CMMLS has seven key components, including:

four active (components that interacts with other components)
Quizzing Engine
Analysis Engine
Gaming Engine (Optional)
Questions Generator;

and three passive (no intelligence involved)
Conceptual Map
Questions Databank
Students Database

The quizzing engine is the heart of the system in certain embodiments of the present invention. In contrast to traditional quizzing engine, the engine built in the CMMLS captures not only the final answer, but also captures the responses to a large number of intermediate steps that a student has to complete in the system; the quizzing engine then captures the intermediate steps and records them in the database. The system records not only the intermediate step answer that a learner provides but also captures the order (which intermediate step does the learner do first) and time (the time required to complete that micro-step).

The analysis engine is the component of the system where data from the quizzing engine, as well as the gaming engine, is utilized to create the skills profile of each student. As the student answers a question in the quizzing engine, the information collected is captured and tabulated into the students' skills stream which is then retrieved by the analysis engine to creates student's skills profile. Data from a series of engagement is captured, along with date of completion. The analysis engine then allows a teacher, parent or student to then benchmark this data against the required standard to get a snapshot of the progress of the student. Note that it is possible to also get a time-trend of the skills of the student by comparing performance over time.

The gaming engine is an optional component of the system. It differs from the quizzing engine in that the interaction that the student has with the system is within a game-like environment or interface, rather than a traditional quizzing or classroom environment. The games are designed such that progress depends on demonstration of mastery of a set of games are designed such that progress depends on demonstration of mastery of a set of mathematical concepts.

The Question Generator is a component which by analyzing student's progress stored in students database is able to produce variable computation based questions and application (word problems) questions which are able to address skills that student struggle, with surgical precision.

Conceptual Maps provide an insight into student's competency into specific area of mathematics. They also enable students, parents, and mentors to see student's performance at a glance, and observe how student progresses over time. Conceptual maps make it possible to compare how student perform in comparison with other students in each aggregate level such as center, region (e.g. state), country and world in a specific time span based on either age or curriculum progress.

Certain embodiments of the present invention comprise specifically designed question databank of more than 100,000 mathematics questions or problems. What separates this databank from a traditional mathematic problem set is that each of the 100,000 question in the databank is broken down into the discrete mini-steps required to solve the problem, so that each questions has a large number of associated identifiers (for each intermediate-step) that holds details of the skills required to solve the problem. These micro-skills identifiers or codes help identify the entire breadth of prior-knowledge skills that a student uses when coming up with the right answer to the question or problem.

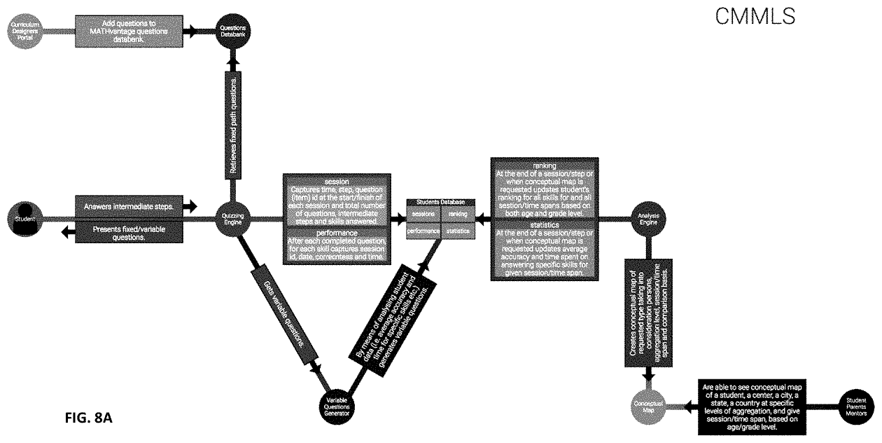

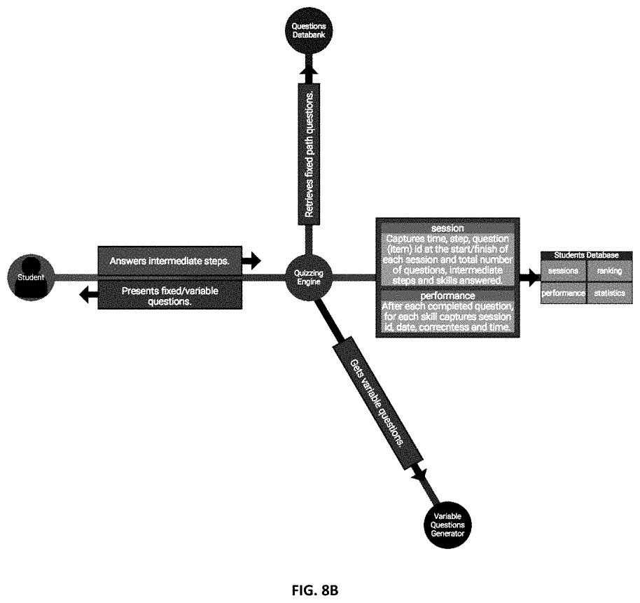

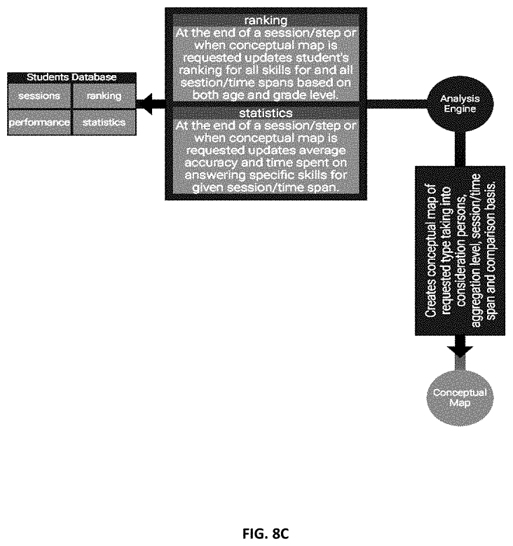

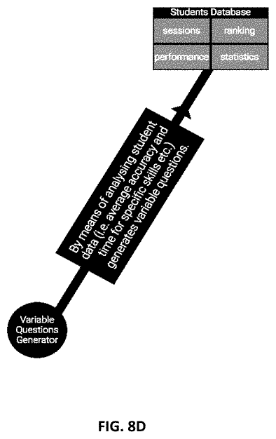

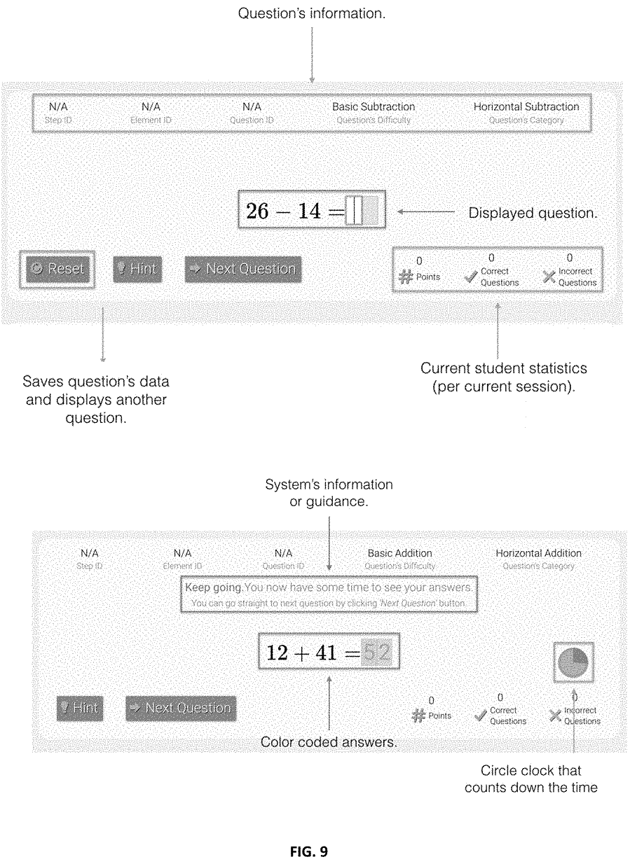

Interaction between different components of CMMLS and its users in certain embodiments of the present invention is visualized by a relation graph shown in FIG. 8A. This diagram shows full path of getting a student skill-profile in a form of conceptual map. It starts with 360 quizzing engine presenting fixed path or variable questions to the student. Then as soon as student completes a question all information is being captured and saved into students database by quizzing engine. Then whenever student, parents or teacher wants to see the conceptual map analysis engine retrieves data within given timespan and produces a conceptual map.

The portion of the quizzing engine in certain embodiments of the present invention is shown in FIG. 8B. The quizzing engine interacts with the student by either presenting fixed path question which is retrieved from the questions databank or variable path as well as application path questions which is got from variable Questions Generator; and ensuring that student answers intermediate steps in particular order. It is responsible for handwritten digit recognition, substituting handwritten digits with typed ones as well as providing student with feedback and correct answers if requested.

In certain embodiments, the quizzing engine interacts with question databank by displaying a fixed path question from particular step, topic, and with specified element ID (within a step).

In certain embodiments, the quizzing engine interacts with Questions Generator by getting a variable or application question that surgically addresses a set of skills that student struggles with and in case of application path question lets students to put the skills in practice. Questions Generator generates variable path questions and application path questions are generated just in time (JiT) when they are requested.

In certain embodiments of the present invention, the quizzing engine interacts with students database by capturing and saving for each student and for each completed question; date when the question has been answered used to determine a skill time trend over a last week, fortnight, month, quarter, half of a year and year; session identifier used to determine a skill sessions-trend over 5, 10 and 20 last session sessions. Session identifier is a simply incremented number whenever students begins a new session and starts from 1; partial times spent on answering intermediate steps; total time spent on answering the question; flag for each of intermediate steps that determine if it was answered correctly and within time threshold; flag that determines if the completed question was answered correctly (if and only if all intermediate steps has been identified as correct); correctly and within time threshold (if and only if all intermediate steps has been identified as correct and within time threshold). Note that student database are not expected to store actual answers but only information about their correctness and time. Also note that By means of capturing both date as well as session identifier analysis engine will be able to determine (within given time span) how many questions where answered correctly, an average, variance.

In certain embodiments, for each session, steps and components include: start (date and time, step, question); finish (date and time, step, question); total time spent; total number of questions answered; total number of intermediate steps answered; and total number of skills enhanced.

For each skill involved in a completed question, steps and components include: date when the question has been answered used to determine a skill time trend over today, last week, last month, last year, overall; session identifier used to determine a skill session-trend over current, last 10 sessions and last 20 sessions. Session identifier is a simply incremented number whenever students begins a new session and starts from 1; time spent on answering intermediate step that involved the skill; and flag that determines if it was answered correctly and within time threshold.

The analysis engine of some embodiments of the present invention is illustrated in FIG. 8C. The analysis engine interacts with students database by updating statistics section with corresponding accuracy and time averages for given session/time span for each skill; and updating both age and level based rankings section with percentiles which are obtained by comparison of persons (a student, a center, a city, a state, a country and the world) statistics worth with other persons at aggregate level.

In certain embodiments of the present invention, the analysis engine interacts with conceptual map by producing it for specific persons (a student, a center, a city, a state, a country and the world) at given level of aggregation (a center, a city, a state, a country and the world) for defined session/time span (current session, last 10 sessions, last 20 sessions, today, last week, last month, last year and overall) and based on chosen comparison basis (an age, a level and performance benchmarks).

In certain embodiments, the analysis engine keeps track of following data: current status, during current session; a moving average of last 10 instance (including this session); a moving average of last 20 instance (including this session); and over time, for: a particular students (at an aggregate level), each skill code (including ones associated with a question as well as an intermediate step), a class (collection of students), a center (collection of classes).

In certain embodiments, for each micro-skill, analysis Engine keeps track of: the percentage of times that a student got this right; current status, during current session; a moving average of last 10 instance (including this session); a moving average of last 20 instance (including this session) and the time it took them to answer the question; current status, during current session; a moving average of last 10 instance (including this session); a moving average of last 20 instance (including this session); and over time.

The Questions Generation in certain embodiments of the present invention is shown in FIG. 8D. The Questions Generator interacts with the students database by analyzing statistics section and is able to provide a list of variable questions which surgically address skills that student struggle with, and a list of application questions which allow student to put his skills into practice.

In certain embodiments, the Quizzing Engine is the heart of the system. In contrast to traditional Quizzing Engine, the engine built in the CMMLS captures not only the final answer, but also captures the responses to many intermediate steps that a student has to complete in the system; the Quizzing Engine captures the intermediate steps and records them in the Students Database. The system records not only the intermediate step answer that a learner provides but also time that student has spent on solving the intermediate step. There are 3 different type of items that Quizzing Engine is expected to display: guideline—an explanation of a concept, example—question with solutions and question—interactive with intermediate steps. It is important to note that there are three types of questions: fixed, variable and application. All types will be displayed through the Quizzing Engine. The fixed questions retrieved from Questions Databank and the variable and application questions are supplied by Questions Generator.

In certain embodiments, the Quizzing Engine is responsible for: displaying questions, examples and guidelines one by one; providing intermediate input boxes that become available in defined order and functionality that converts handwritten digit into a typed equivalent; capturing correctness of student's answer to an intermediate step, time that student has spent on solving an intermediate step, and if correct answer was provided; and allowing to reset inputted answers to start from scratch and get a hint. Once ‘submit’ button is clicked, the button doesn't allow students to change their answers. The student's answers are color-coded to show which answers to intermediate steps were correct. The correct answers might be seen. All data that has been captured for this question is formatted and then passed to Analysis Engine which will save it to User Database Retrieving/Requesting Questions. Items such as guidelines, examples and fixed path questions are stored in the Questions Databank.

In certain embodiments, after student has completed all questions on a fixed path in a specific step/topic, Quizzing Engine will be responsible to ask student additional set of questions from variable and application paths which will be requested from Questions Generator.

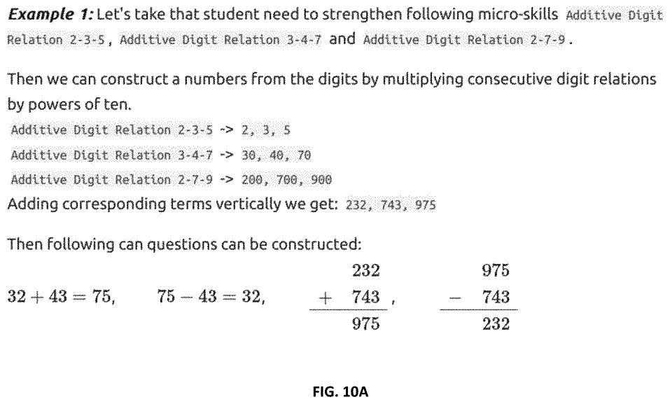

FIG. 9 shows an example of quizzing interface.

In one embodiment of the implementation of the quizzing engine, questions are written with LaTeX and rendered with MathJax. Extension that allows for creating intermediate input boxes is called form input and has to be set up appropriately. Note that id of a \FormInput identifies the order in which intermediate steps must be answered by student.

In some embodiments, a Handwritten Digit Recognizer is implemented as a separate module and imported into the Quizzing Engine. To achieve it intermediate input boxes will have to be treated as a canvas that student can draw on and as soon as student is finished with writing such handwritten digit should be replaced by corresponding typed digit. It is very important to understand that student can only write in only open input box, and as soon as students starts writing in next one the previous one becomes disabled and the next one opens.

The time that student has spent on answering particular intermediate step is defined as last touch with a canvas from previous intermediate step up to last touch with the canvas with current intermediate step. In case of keyboard input (including on-screen keyboard) the time would be defined as time between the key presses.

In certain embodiments, as student answers by writing answers into intermediate boxes, the Quizzing Engine keeps track of time that student spent on getting intermediate answer. The correctness of an answer is determined by comparing recognized handwritten number with a correct answer for the intermediate step. The Quizzing Engine also keeps track of the skill codes that have been blinded to particular intermediate step. Note that the Quizzing Engine is expected to store this data for each skill code, not each intermediate step. A single intermediate step has usually at least two micro-skill codes. Hence, for each micro-skill in each intermediate step Quizzing Engine is expected to capture and savefollowing data in the skills stream: timestamp, step/question, skill, isCorrect, time, correct_in_time—determines whether student answered question correctly and within defined time thresholds.

In some embodiments, there are a few requirements and preferences in regards to Quizzing Engine: It must be able to display questions, instructions and guidelines; It must display questions/instructions/guidelines one by one; It must retrieve an information about which question is to be asked next from the Students Database; It must ask student additional/variable questions after fixed path questions for give step/topic are finished and request these additional questions from the Analysis Engine module called Variable Questions Generator.

In some embodiments, the Quizzing Engine renders questions by means of MathJax with FormInput as an extension module; It must show if each intermediate answer is correct/incorrect after submitting the question (after the final answer is provided), however, showing correct answer is not intended until student is finished with answering the question or it is requested otherwise by student.

In some embodiments, requirements regarding intermediate boxes include: When the question is presented only one intermediate input box must be open which is labelled with A1 identifier (unless adjacent intermediate steps have exactly the same set of micro skills). The rest must be disabled so that the student cannot write in them; As soon as student starts handwriting in currently open intermediate input box the next in turn intermediate box will become available (more that one intermediate box will be open if there are adjacent intermediate steps with the same set of micro skills); Then as soon as students writes in newly open intermediate input box the previous one will be disabled and again next in turn intermediate box will become available; This process repeats until question is completed; Each intermediate input box that becomes disabled after being written to must be replaced with corresponding recognized digit by Handwritten Digit Recognition System which shall be implemented as a separate module and imported to Quizzing Engine; Student must be able into intermediate input box in a predefined order which is defined in LaTeX code in \FormInput{A#} where # define the order in which intermediate input boxes will become available; Student must be able to flag a recognized digit that is in his/her opinion inaccurately recognized; Student must be able to enter his/her answer with an e-pen or a finer on a tablet; In case of conscious mistake student must be able to reset a question and start from scratch, however we either allow a maximum of 2 of such operations and/or flag data that comes from a question that was reset and answered again.

In some embodiments, requirements in regard to capturing data include: It must capture time which student has spent on solving particular intermediate step (micro-skill). Recall algorithm for computing this time from Capturing Time section. It must determine if student's answer for particular intermediate step is correct. It must determine if student's answer for particular intermediate step is correct and was provided within predefined time threshold for particular skill code. It must be able to process and display different type of questions.

In some embodiments, other Requirements include: It won't allow to change digit that has been written into the intermediate input box. It won't allow to change any answers after submitting a question. It won't allow the same question to be displayed more than once on the fixed path. It won't allow student to exploit the system by skipping questions, getting hints, showing solutions, quitting an app etc.

The Gaming Engine of certain embodiments of the present invention is described as follows. All games will have some functionality in common, however, Gaming Engine, should be customized for each game with respect to what questions are created and what student's data is captured. The Analysis Engine will provide a Gaming Engine with a list of key and value paired skill and frequency factor (probability that given skills will be chosen) respectively and Gaming Engine will be expected to use this information to create ‘questions’ in a game. For example, in a game where student is expected to connect rocks floating in a river game. A skill such as MT 3-4-12 can be chosen choose from a list and the game engine creatse two rocks labeled with number 3 and 4. Each game will be provided with an information for Students Database as an input and will be expected to return output to the Analysis Engine.

In some embodiments, each MATHvantage game (i.e. Gaming Engine) is provided by means of Analysis Engine with a list in which each element is an object with a single key and value pair. Skill code will be used as a key and corresponding value will be a Frequency Factor F % which describes likelihood of testing/asking specific skill in a game. By means of this list Gaming Engine will be expected to randomly choose a skill and use it in a game. Gamin engine will be expected to combine and format captured information in a Gaming Interface and then pass it to Analysis Engine for further evaluation and saving to the Students Database.

For a specific game, the Gaming Interface is fully customized based on the game structure. However, in general, the following data need to be captured by Gaming Interface, then formatted by Gaming Engine, passed to Analysis Engine to evaluate and finally stored in the Students Database. The data include: micro-skill, category code, computational skill code (if applicable), timestamp (date time), correctness (Simply true of false), time that student took to answer (if possible), Alternative skills that student could use to solve the question but haven't (if applicable).

Note that for certain games it will be impossible to register time that student has taken to answer a question due to the fact that student had many options to choose from. Similarly, alternative skills would only be relevant if student could achieve the target with different numbers. All these details should be addressed.

In some embodiments, the Questions Generator puts the idea of generating variable questions (that are not part of fixed path) on the fly which quizzing engine can request at any moment after student has finished answering questions on a fixed path. At the end of each step after student is done answering these fixed path questions student will be asked a number of variable questions (which will vary in difficulty and a number of skills strengthened). The main purpose of this is to help student gain proficiency in a given set of skills as efficiently as it has never been done in the past by means of uniquely crafted question that are meant to address student's struggles with surgical precision.

In some embodiments, compound variable questions target a subset of 2, 3 or 4 skills where the focus is now on combining skills that student struggle with in order to help student gain confidence and master a particular skill.

Variable questions can be either isolated and compound. Variable questions section will start with questions that get students to practice 1-2 micro-skills, and then later in that session, as they have mastered/practiced those micro-skills in isolation (isolated variable questions), then they will be provided with a few questions that involve multiple micro-skills that they have struggled with (compound variable questions).

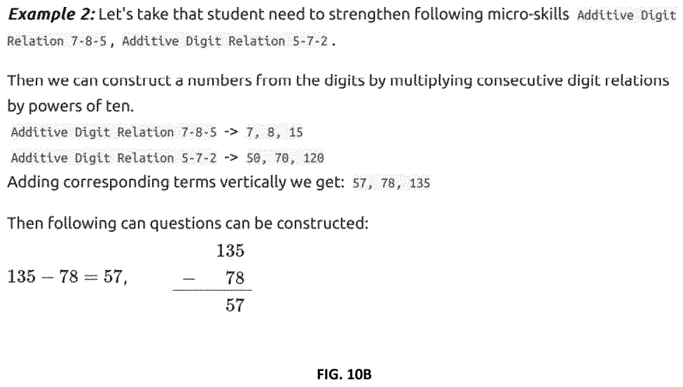

An example of Additive Digit Relation is used to illustrate the method described in the present invention. For Additive Digit Relation a-b-c, if a+b=c then following questions can be constructed: horizontal maxlength: 2 (addition, subtraction); vertical maxlength: ¾ (addition, subtraction). If a+b!=c, then it means that carrying for addition or borrowing for subtraction will take place and only vertical subtraction can be constructed. FIGS. 10A and 10B illustrate two examples of Additive Digit Relation.

In some embodiments, the questions databank is the central repository that contains the 100,000 or more mathematical questions (problems) that cover mathematics subjects from grades K-12. Questions Databank ((QD is a where questions, guidelines and examples of the fixed path are stored and are accessible for Quizzing Engine. The subjects to be covered include: Introduction to Counting and Numbers; Arithmetic including Addition (Horizontal and Vertical Addition), Subtraction (Horizontal and Vertical Subtraction), Multiplication (include Long Multiplication), Division (include Long Division), Fractions, Decimals, Positive/Negative Numbers, Positive/Negative Numbers; Algebra including Linear Equations, Inequalities & Graphing, Factorization, Square Roots, Quadratic Equations, Fractional Functions, Irrational Functions, Exponential Functions; Logarithms; Vectors; Matrices; Statistics; Trigonometry including Triangles, Circles, Loci, Sequences and Series, Addition Theorem; Calculus; Limits; Differentiation; Advanced Differentiation; and Integration Differential Equations.

In some embodiments, the questions databank comprises many modules (called steps or levels), which closely mirror the breakdown above. The mandatory questions from fixed path will be presented to each student in a specified order. Each student (unless he/she has tested out of that particular step by virtue of results in the placement test), will be presented with the question, and will be expected to answer the placement test), will be presented with the question, and will be expected to answer the question, at least once. As the learner answers the question, their speed and accuracy will be benchmarked against a minimum threshold. If their actual performance compares favorably against the required benchmark, the learner will be able to move to the next module. However, if the performance is not in line with the required standard (in terms of timely, no-mistake completion) then the student will be shown another set of optional questions from a variable path and application (automatically generated ones which address skills that student has struggled with).

In the students database of certain embodiments of the present invention, each student will have following objects: personal information—captured on student's registration; ranking—gets updated by analysis engine after each completed step/session; statistics—gets updated by analysis engine after each completed step/session; sessions—gets written by quizzing engine after each finished session; performance—gets written by quizzing engine after each completed question;

In some embodiments, students are ranked against other students in their age in the specified geological range, such as across a center, a region, a country, and the world. Ranking is expressed in percentiles. Analysis engine is responsible for updating both age and level based rankings. Leaderboards are updated automatically in a timely fashion. All leaderboards are based on age.

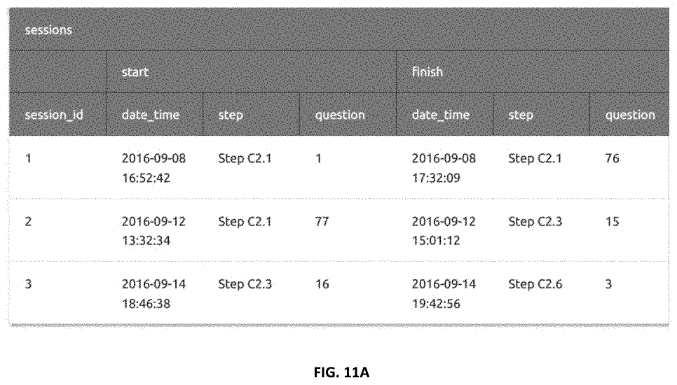

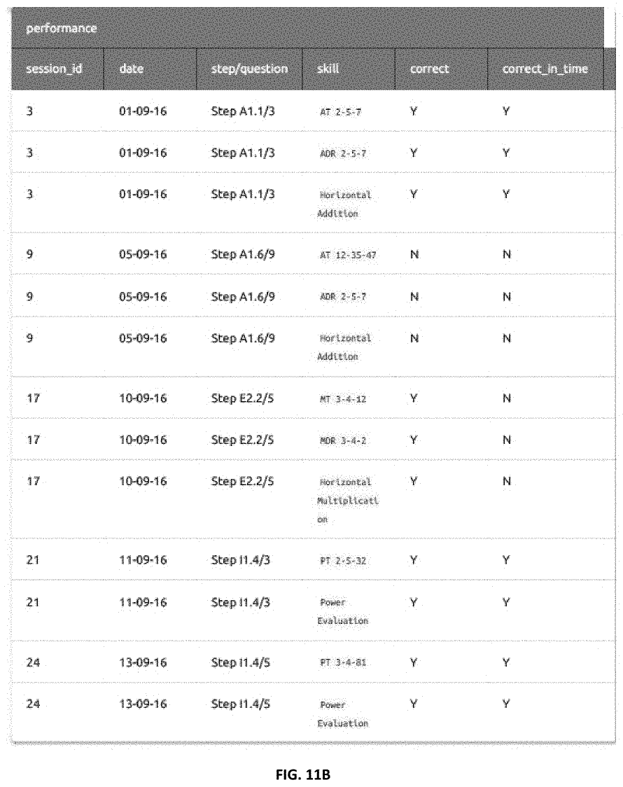

In some embodiments, for each micro-skill in each intermediate steps and each category code in each question, the quizzing engine is expected to capture and store the following data: timestamp (date time)—to enable analysis engine to identify time trends; skill—either a micro-skill or a category code; correct—determines if intermediate step which involved specific micro-skill was answered correctly or not and in case of category code determines if a question was answered correctly or not; time—that took student to answer intermediate step which involved specific micro-skill or a time taken to answer a question (all intermediate steps in that question) in case of category codes. FIG. 11A shows an example of display of session information. FIG. 11B shows an examples of data display for student performance.

In certain embodiments, a mathematical intelligence quotient (MIQ) may be calculated for the student. The MIQ estimates student's mathematical intelligence taking into consideration a student's age. It is a measure of mathematical knowledge, skill and aptitude relative to the student's age group around the world. The average MIQ by definition is 100. A value above 100 indicates a higher than average MIQ and scores below 100 indicate a lower than average MIQ.

In certain embodiments, to calculate the MIQ, a Math Score of each student may be calculated first and then the Math Score is compared with the average Math Scores of students of the same age. The Math Score measures the breadth of mathematical competencies of a student. It represents the student's skills and breadth of knowledge and also represents the advancement in the curriculum.

In certain embodiments, the Math Score may be calculated as a weighted average of the scores obtained within a multitude of micro-skills. These scores measure the proficiency of the student in each of these micro-skills and are a function both of correctness (how many time did the student demonstrate this micro-skill correctly) and fluency (how much time did it take the student to answer correctly).

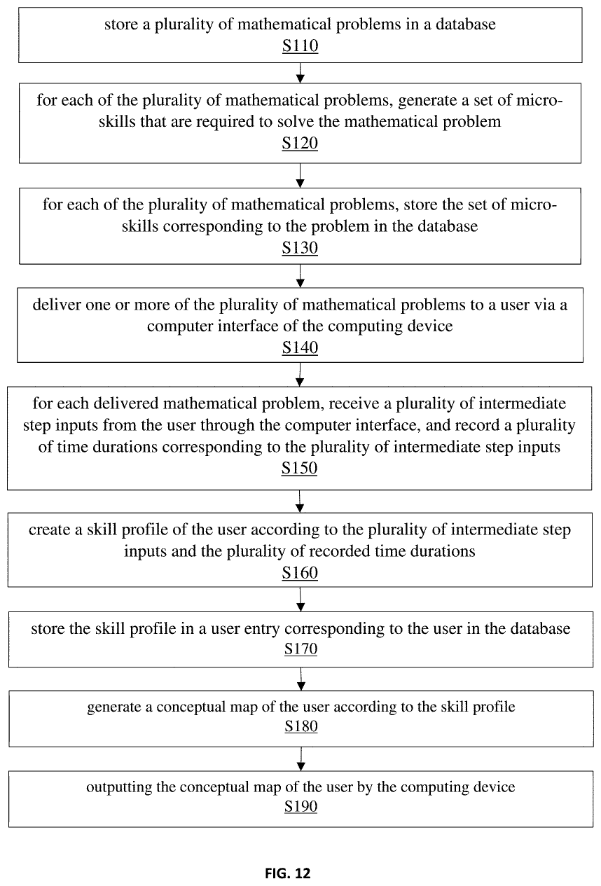

To summarize the forgoing descriptions, the present disclosure provides a method for learning and assessment using a computing device. FIG. 12 illustrates the method according to certain embodiments. As shown in FIG. 12, the method includes the following steps. Step S110 is to store a plurality of mathematical problems in a database. In Step S120, for each of the plurality of mathematical problems, a set of micro-skills that are required to solve the mathematical problem is generated. The set of micro-skills are selected from a plurality of pre-defined micro-skills, each micro-skill being a smallest component of learning. In Step S130, for each of the plurality of mathematical problems, the set of micro-skills corresponding to the problem in the database is stored. Step S140 is to deliver one or more of the plurality of mathematical problems to a user via a computer interface of the computing device. In Step S150, for each delivered mathematical problem, a plurality of intermediate step inputs are received from the user through the computer interface and a plurality of time durations corresponding to the plurality of intermediate step inputs are recorded. Step S160 is to create, by the computing device, a skill profile of the user according to the plurality of intermediate step inputs and the plurality of recorded time durations. The skill profile includes skill levels of the user in a plurality of micro-skill categories. Step S170 is to store the skill profile in a user entry corresponding to the user in the database. Step S180 is to generate, by the computing device, a conceptual map of the user according to the skill profile; and outputting the conceptual map of the user by the computing device.

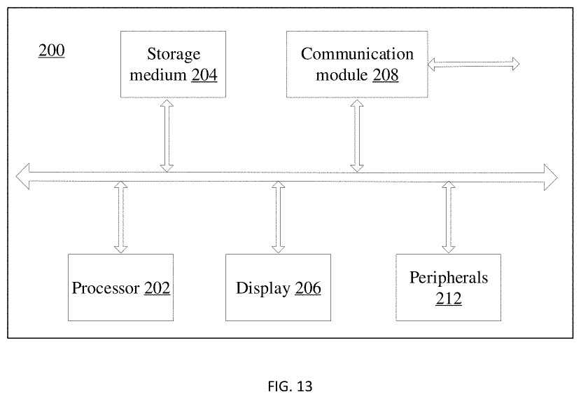

The forgoing method may be implemented by a device. In certain embodiments, the device may be a computing device. FIG. 13 illustrates the computing device according to certain embodiments. As shown in FIG. 13, the computing device may include a processor 202 and a storage medium 204. According to certain embodiments, the computing device may further include a display 206, a communication module 208, and additional peripheral devices 212. Certain devices may be omitted and other devices may be included.

Processor 202 may include any appropriate processor(s). In certain embodiments, processor 202 may include multiple cores for multi-thread or parallel processing. Processor 202 may execute sequences of computer program instructions to perform operations in the forgoing method. Storage medium 204 may be a non-transitory computer-readable storage medium, and may include memory modules, such as ROM, RAM, flash memory modules, and erasable and rewritable memory, and mass storages, such as CD-ROM, U-disk, and hard disk, etc. Storage medium 204 may store computer programs for implementing various processes, when executed by processor 202, cause the processor to perform steps of the forgoing method. The communication module 108 may include network devices for establishing connections through a network. Display 106 may include any appropriate type of computer display device or electronic device display (e.g., CRT or LCD based devices, touch screens). Peripherals 112 may include additional I/O devices, such as a keyboard, a mouse, and so on.

The foregoing description and accompanying drawings illustrate the principles, preferred or example embodiments, and modes of assembly and operation, of the invention; however, the invention is not, and shall not be construed as being exclusive or limited to the specific or particular embodiments set forth hereinabove.

What is claimed is:

1. A method for learning and assessment using a computing device, including:
storing a plurality of mathematical problems in a database;
for each of the plurality of mathematical problems, generating, by the computing device, a set of micro-skills that are required to solve the mathematical problem, the set of micro-skills being selected from a plurality of pre-defined micro-skills, each micro-skill being a smallest component of learning;
for each of the plurality of mathematical problems, storing the set of micro-skills corresponding to the problem in the database;
delivering one or more of the plurality of mathematical problems to a user via a computer interface of the computing device;
for each delivered mathematical problem, receiving a plurality of intermediate step inputs from the user through the computer interface, and recording a plurality of time durations corresponding to the plurality of intermediate step inputs;
creating, by the computing device, a skill profile of the user according to the plurality of intermediate step inputs and the plurality of recorded time durations, the skill profile including skill levels of the user in a plurality of micro-skill categories;
storing the skill profile in a user entry corresponding to the user in the database;
generating, by the computing device, a conceptual map of the user according to the skill profile; and
outputting the conceptual map of the user by the computing device.

2. The method according to claim 1, further comprising:
assigning a plurality of skill codes to the plurality of pre-defined micro-skills.

3. The method according to claim 1, further comprising:
assigning a set of category codes to each of the plurality of mathematical problems, each category code corresponding to a category of mathematical knowledge required to solve the mathematical problem.

4. The method according to claim 1, wherein generating the conceptual map of the user according to the skill profile includes:
generating benchmark skill levels of the user by comparing the skill levels of the user to predefined standard skill levels in the plurality of micro-skill categories; and
color-coding the benchmark skill levels of the user in the plurality of micro-skill categories.

5. The method according to claim 4, wherein the pre-defined standard skill levels are generated based on one of: average skill levels of all learners across the globe of a same age range, average skill levels of all learners across the globe of a same grade, and average skill levels of learners within a same geographical boundary.

6. The method according to claim 5, further comprising evaluating, by the computing device, performance of the user based on one of a percentile, a median, a standard deviation, and an average measured according to the pre-defined standard skill levels.

7. The method according to claim 4, further comprising:
updating the pre-defined standard skill levels according to a plurality of previously-generated user entries.

8. The method according to claim 1, further comprising:
storing demographic information of the user in the user entry in the database.

9. The method according to claim 1, further comprising:
selecting the one or more mathematical problems to deliver to the user according to a previously-generated skill profile of the user.

10. The method according to claim 1, further comprising:
generating one or more variable-path mathematical problems to deliver to the user according to a previously-generated skill profile of the user, wherein each variable-path mathematical problem is associated with one or more micro-skills and/or one or more category codes that have been selected for the user to practice according to the previously-generated skill profile.

11. The method according to claim 10, further comprising:
generating one or more application-path mathematical problems to deliver to the user according to a previously-generated skill profile of the user, wherein the application math mathematical problems are word problems related to practical applications.

12. The method according to claim 1, wherein the plurality of mathematic problems stored in the database include 100,000 or more mathematic problems.

13. The method according to claim 1, wherein the plurality of pre-defined micro-skills include 100 or more micro-skills and the plurality of category codes include 100 or more category codes.

14. The method according to claim 1, wherein receiving the plurality of intermediate step inputs includes:
receiving handwritten input form the user through the computer interface; and
converting the handwritten input into one or more of a text, a number, and a formula through text and template recognition.

15. The method according to claim 1, further comprising:
calculating a mathematical intelligence quotient (MIQ) of the user, including:
calculating a math score of the user as a weighted average of scores obtained for at least two micro-skills, and
normalizing the math score of the user to an average math score of students in a same age range.

16. The method according to claim 1, further comprising:
delivering one or more of the plurality of mathematic problems to the user in a computer game environment on the computing device, wherein the computer game environment provides a plurality of game scenarios, each game scenario being associated with one or more micro-skills that have been selected for the user to practice according to a previously-generated skill profile of the user.

17. A non-transitory computer readable storage medium storing a set of computer-executable instructions, wherein when being executed by a processor, the set of computer-executable instructions cause the processor to:
store a plurality of mathematical problems in a database;
for each of the plurality of mathematical problems, store a set of micro-skills corresponding to the problem in the database, the set of micro-skills being selected from a plurality of pre-defined micro-skills;
deliver one or more of the plurality of mathematical problems to a user via a computer interface of the computing device;
for each delivered mathematical problem, receive a plurality of intermediate step inputs from the user through the computer interface, and record a plurality of time durations corresponding to the plurality of intermediate step inputs;
create a skill profile of the user according to the plurality of intermediate step inputs and the plurality of recorded time durations, the skill profile including skill levels of the user in a plurality of micro-skill categories;
store the skill profile in a user entry corresponding to the user in the database;
generate a conceptual map of the user according to the skill profile; and
output the skill map of the user.

18. The non-transitory computer readable storage medium according to claim 17, wherein the set of computer-executable instructions further cause the processor to:
assign a plurality of skill codes to the plurality of pre-defined micro-skills.

19. The non-transitory computer readable storage medium according to claim 17, wherein the set of computer-executable instructions further cause the processor to:
assign a set of category codes to each of the plurality of mathematical problems, each category code corresponding to a category of mathematical knowledge required to solve the mathematical problem.

20. The non-transitory computer readable storage medium according to claim 17, wherein the set of computer-executable instructions further cause the processor to:
generate benchmark skill levels of the user by comparing the skill levels of the user to predefined standard skill levels in the plurality of micro-skill categories; and
color-code the benchmark skill levels of the user in the plurality of micro-skill categories.
